(19) United States
(12) Patent Application Publication
(10) Pub. No.: US 2010/0213302 A1
(43) Pub. Date: Aug. 26, 2010

(54) Retractor assembly

(75) Inventor: Mark F. Gray, Sterling Heights, MI (US)

Correspondence Address: FOLEY AND LARDNER LLP;SUITE 500, 3000 K STREET NW, WASHINGTON, DC, 20007, US

(73) Assignee: TK HOLDINGS INC.

(21) Appl. No.: 12/379,663

(22) Filed: Feb. 26, 2009

(51) Int. Cl. B60R 22/34; B60R 22/46; B65H 75/48; B60R 22/36

(52) U.S. Cl. 242/374; 242/382

(57) ABSTRACT

A retractor for a vehicle seat belt includes a spool configured to rotate so that the seat belt may be wound and unwound from around the spool. The retractor also includes a torsion bar located within the spool. The retractor is configured so that the inner or outer members are selectively connected to a lock mechanism and so that during a first loading condition either the first end of the inner member or the first end of the outer member is fixed to the lock mechanism and during a second loading condition both of the first ends of the inner and outer members are connected to the lock mechanism.

### BACKGROUND

The present application relates generally to the field of seat belt retractors, which are used for spooling seat belt webbings. Retractors are commonly used in seat belt systems for restraining an occupant of a vehicle seat. In particular, this application relates to a retractor assembly including a load limiting member or torsion bar assembly, which provides improved occupant safety through multiple levels of energy management.

A seatbelt device for use within a motor vehicle provides safety to an occupant by restraining the movement of the occupant during a sudden deceleration, typically resulting from a dynamic impact event of the vehicle. A typical seatbelt device includes a webbing or belt, a buckle, a tongue member to engage the buckle, a retractor, and an anchor member. Retractors include a spool and through the use of a force, often generated by a spring, wind the webbing around the spool in the retraction or winding direction. During a collision or other similar event involving the vehicle, the retractor may be configured to lock the seat belt webbing in position and prevent the webbing from moving in the withdrawal or extraction direction thereby restricting movement of the occupant.

A seat belt retractor may have a load absorbing capability in order to reduce the load applied to the occupant in the event of a crash or other similar event involving the vehicle. For example, a retractor may include a single load limiting device. The load limiting device may be a torsion bar that deforms torsionally when subjected to a torque. The torsion bar absorbs energy during deformation, which results from loading applied to the retractor as a result of the occupant being subjected to a sudden deceleration of the vehicle. Typically, one end of the torsion bar is held fixed, while the other end is coupled to and rotates with the spool. As the restraint forces on the webbing increase, the seat belt webbing imparts a corresponding increasing force onto the spool of the retractor, which generates an increasing torque onto the non-fixed end of the torsion bar. When sufficient torque is reached, the torsion bar deforms torsionally, absorbing energy and allowing the seat belt webbing to extract thereby providing energy absorption and improved safety to the occupant.

Other retractors may provide a switchable energy absorbing configurations that include more than one load limiting device. There are two types of switchable load management retractors, each type having disadvantages. One type of switchable load management retractor includes two load limiting devices or torsion bars positioned in series (i.e., both configured proximate and substantially linear within the spool assembly, having different torsional strengths). The torsion bars are essentially positioned end to end within the spool. Under certain criteria (e.g., low severity crash, low occupant weight) only one torsion bar is engaged, and under different predetermined criteria (e.g., high severity crash, high occupant weight) both torsion bars are engaged. The main disadvantage to this dual series type torsion bar configuration is that when the shift or switch occurs and the second load limiting device engages the spool, there is an immediate drop in energy absorption because second load limiting device incurs increased strain or deflection while it is loaded within its elastic range. Later, the load absorption increases when the second load limiting device transfers from elastic to plastic deformation.

The second type of switchable load management retractors include two load limiting devices or torsion bars positioned in parallel. Typically, one torsion bar is located within the spool and the other is located external to the spool. The two torsion bars have different torsional strengths. When energy absorption is required, both torsion bars are engaged and in the load path. As a result, this configuration does not suffer from the spikes in loading. However, the main disadvantage is that the retractor is quite large due to the requirement for two retractors located in parallel. The retractor requires a large space in the vehicle, which is typically undesirable.

Accordingly, there is a need for a load limiting retractor that can provide energy absorption during vehicle dynamic impact events, while providing smooth load management in a smaller, cost effective package.

### SUMMARY

It is the object of at least one disclosed embodiment to provide a load limiting retractor assembly that absorbs energy during dynamic vehicle impact events in a smooth manner with respect to time, and to provide duel levels of energy management or energy absorption that may be activated depending on the severity of the vehicle impact event. This application provides a load limiting retractor assembly with improved occupant protection that is cost, mass, and volume efficient.

According to one embodiment, a retractor assembly includes a spool, a torsion bar located within the spool, a lock mechanism, and a biasing mechanism. The spool is configured to rotate to wind or unwind the seat belt webbing. The biasing mechanism biases the rotation of the spool in the winding direction to remove slack from between the webbing and an occupant. The lock mechanism is engaged during vehicle impact events to prevent rotation of the spool in the unwinding direction and prohibiting the seat belt webbing from extracting during the impact. The torsion bar is configured with an inner member that is coupled at one end to the lock mechanism and coupled at the other end to the spool and upon engagement of the lock mechanism torque is transferred through the inner member of the torsion bar causing it to deform elastically and yield plastically, absorbing occupant energy exerted onto the webbing resulting from the impact event. The torsion bar is also configured with an outer member that is coupled at one end to the lock mechanism and engagably coupled at the other end to the spool. During higher severity vehicle impact events, the outer member is coupled to the spool through an engaging member, transferring torque through the outer member causing it to deform elastically and yield plastically, absorbing occupant energy exerted onto the webbing resulting from the impact event. Thus in higher severity vehicle impact events, both the inner and outer members transfer torque and absorb energy. During lower severity vehicle impact events, the engaging members remain disengaged from the outer member of the torsion bar, thus allowing torque to be transferred through only the inner member of the torsion bar.

According to another embodiment, a retractor assembly includes a spool, a torsion bar located within the spool, and a lock mechanism. The spool is configured to rotate to wind or unwind the seat belt webbing. The lock mechanism is engaged during vehicle impact events to prevent rotation of the spool in the unwinding direction and prohibiting the seat belt webbing from extracting during the impact. The torsion bar is configured with an inner member that is coupled at one end to the lock mechanism and coupled at the other end to the spool and upon engagement of the lock mechanism torque is transferred through the inner member of the torsion bar causing it to deform elastically and yield plastically, absorbing occupant energy exerted onto the webbing resulting from the impact event. The torsion bar is also configured with an outer member that is coupled at one end to the spool and engagably coupled at the other end to the lock mechanism. During higher severity vehicle impact events, the outer member is coupled to the lock mechanism through an engaging member, transferring torque through the outer member causing it to deform elastically and yield plastically, absorbing occupant energy exerted onto the webbing resulting from the impact event. Thus in higher severity vehicle impact events, both the inner and outer members transfer torque and absorb energy. During lower severity vehicle impact events, the engaging members remain disengaged from the outer member of the torsion bar, thus allowing torque to be transferred through only the inner member of the torsion bar.

According to another embodiment, a retractor assembly includes a spool, a torsion bar located within the spool, a lock mechanism, and a biasing mechanism. The spool is configured to rotate to wind or unwind the seat belt webbing. The biasing mechanism biases the rotation of the spool in the winding direction to remove slack from between the webbing and an occupant. The lock mechanism is engaged during vehicle impact events to prevent rotation of the spool in the unwinding direction and prohibiting the seat belt webbing from extracting during the impact. The torsion bar is configured with an inner member and outer member that are substantially in contact along the entire length of the torsion bar. The inner member is coupled at one end to the lock mechanism and coupled at the other end to the spool and upon engagement of the lock mechanism torque is transferred through the inner member of the torsion bar causing it to deform elastically and yield plastically, absorbing occupant energy exerted onto the webbing resulting from the impact event. The outer member is coupled at one end to the lock mechanism and engagably coupled at the other end to the spool. During higher severity vehicle impact events, the outer member is coupled to the spool through an engaging member, transferring torque through the outer member causing it to deform elastically and yield plastically, absorbing occupant energy exerted onto the webbing resulting from the impact event. Thus in higher severity vehicle impact events, both the inner and outer members transfer torque and absorb energy. During lower severity vehicle impact events, the engaging members remain disengaged from the outer member of the torsion bar, thus allowing torque to be transferred through only the inner member of the torsion bar.

### BRIEF DESCRIPTION

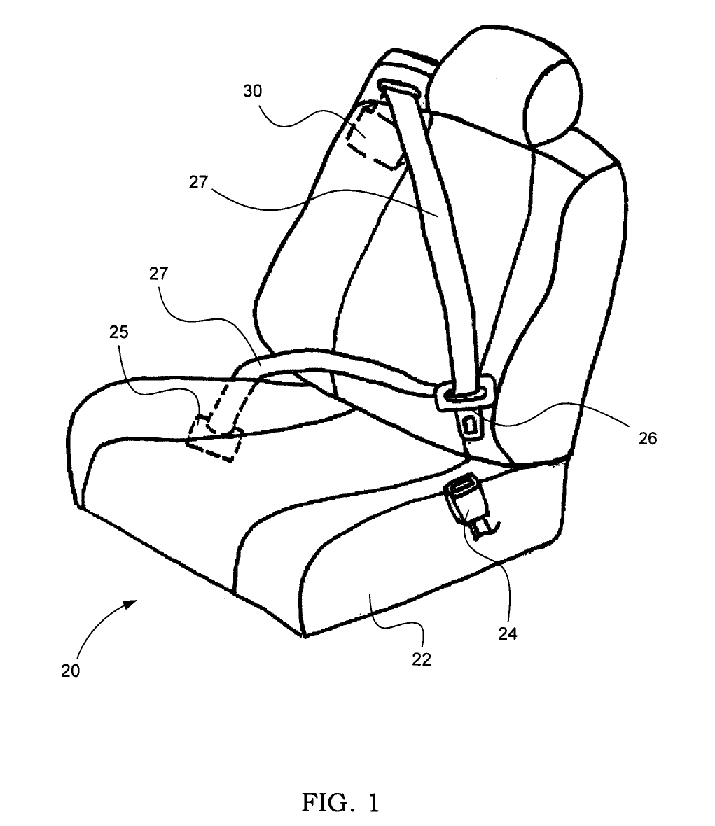

FIG. 1 is an exemplary embodiment of a safety system incorporated directly into a seat assembly, for use within a motor vehicle.

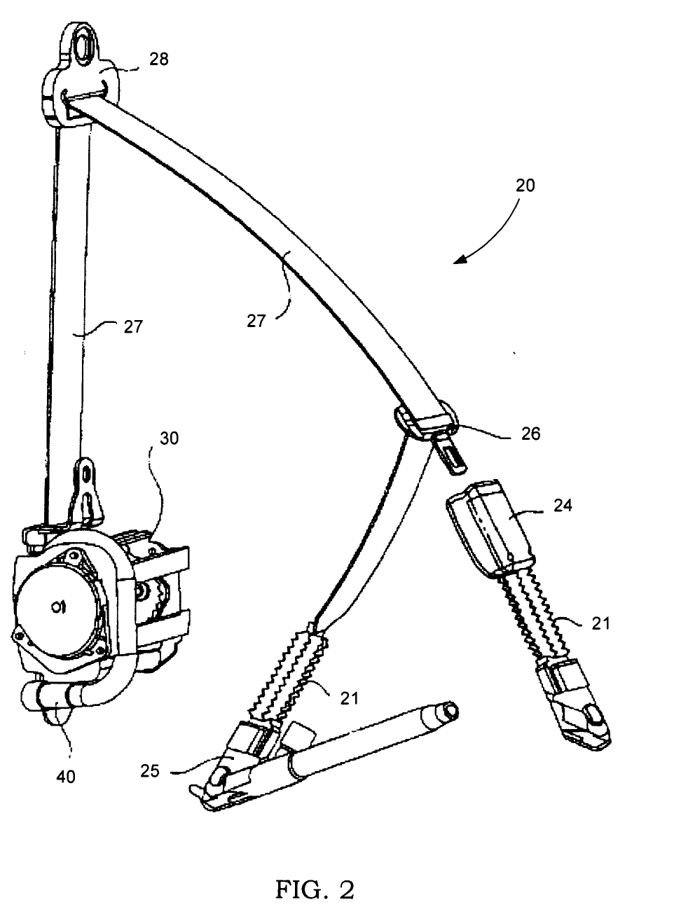

FIG. 2 is another exemplary embodiment of a safety system.

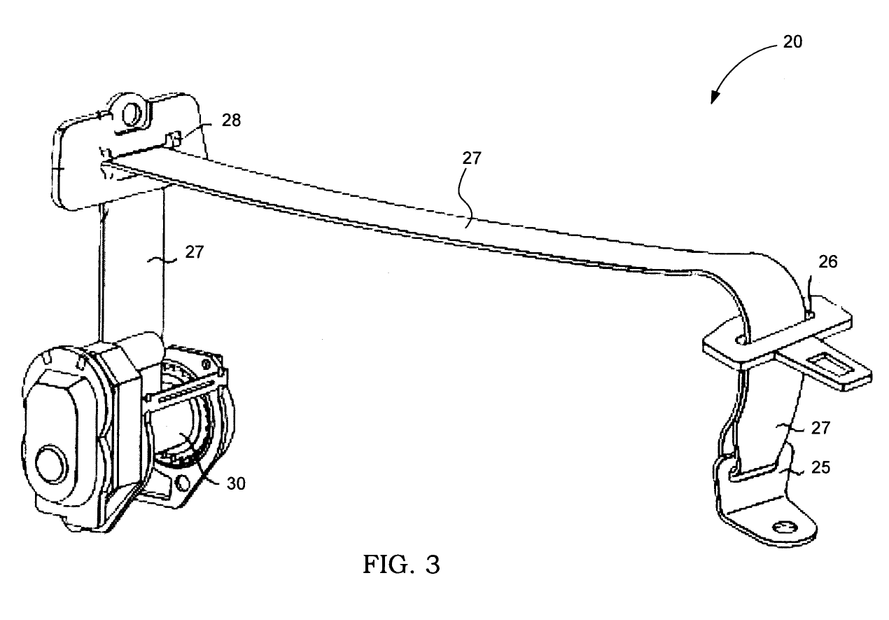

FIG. 3 is yet another exemplary embodiment of a safety system.

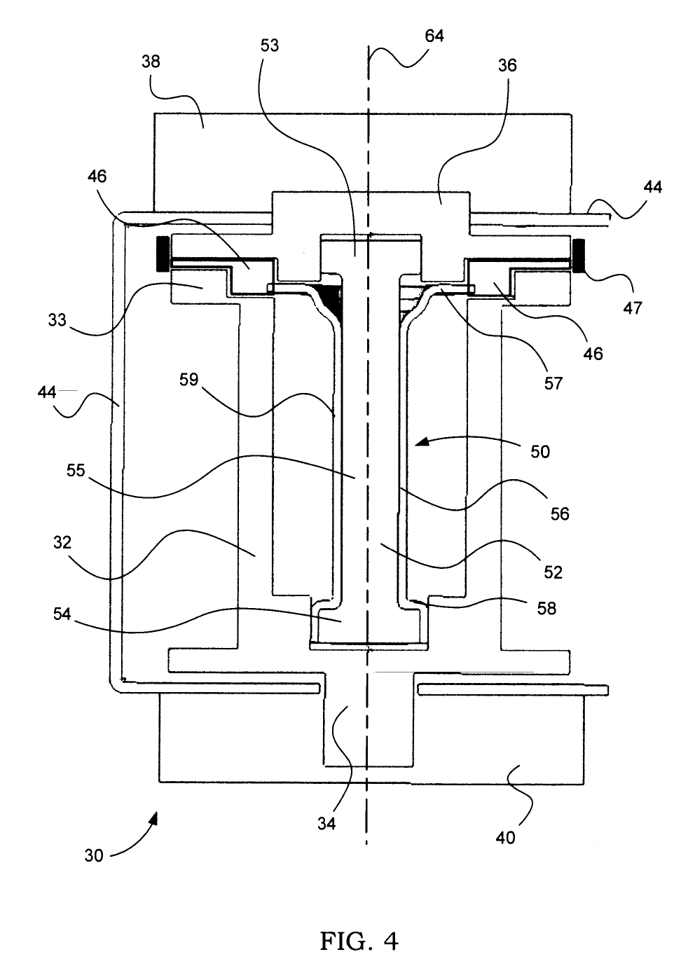

FIG. 4 is an exemplary embodiment of a retractor assembly for use within a safety system, such as the safety system of FIG. 1.

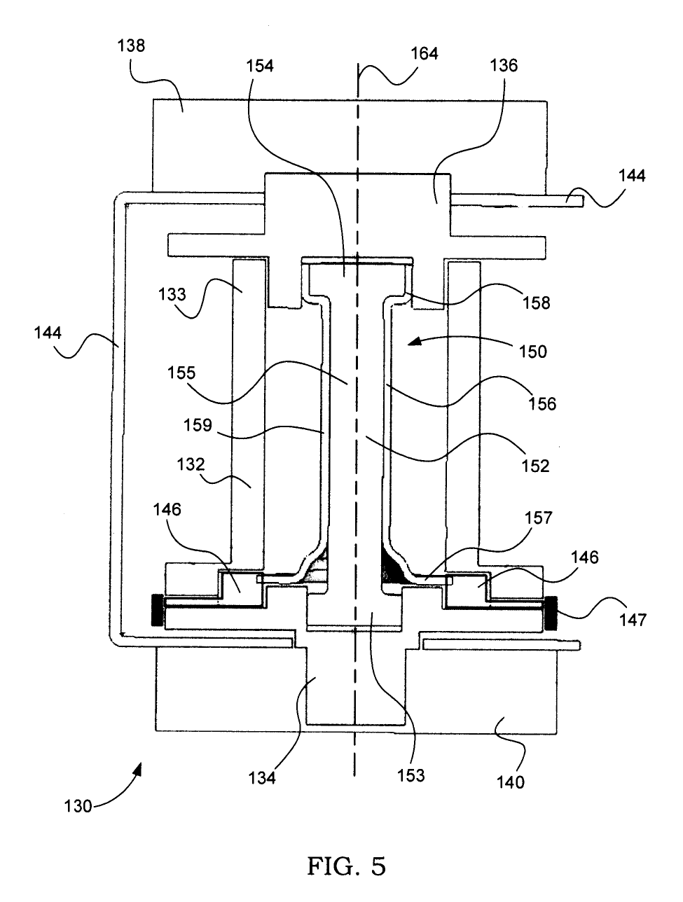

FIG. 5 is another exemplary embodiment of a retractor assembly for use within a safety system, such as the safety system of FIG. 1.

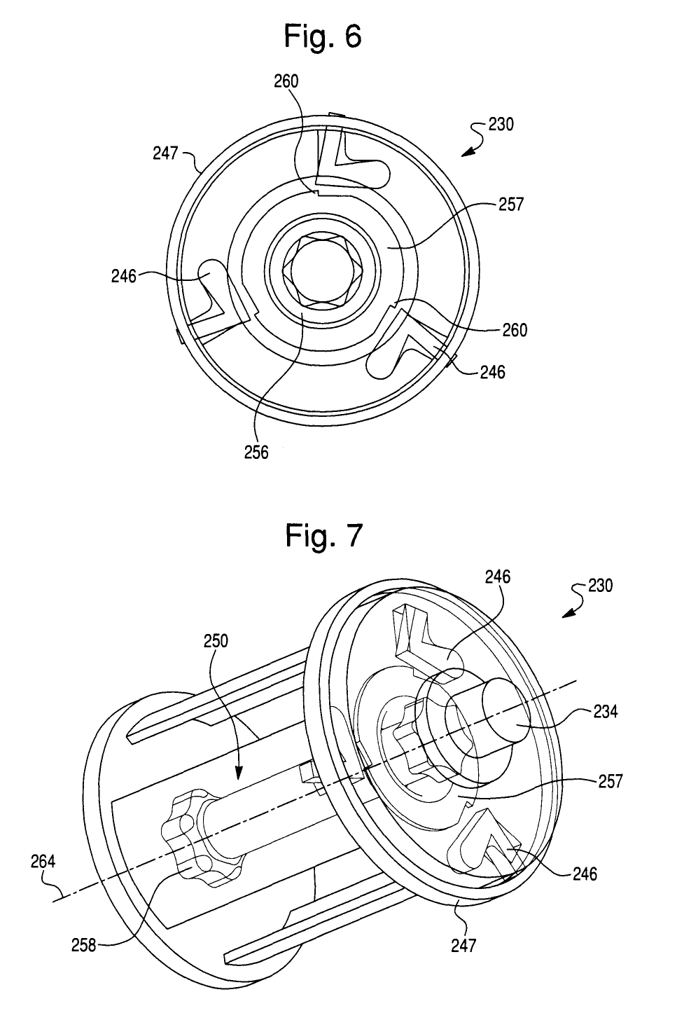

FIG. 6 is a side view of the retractor assembly of FIG. 5 with the outer member in the non-loading or unlocked condition.

FIG. 7 is a perspective view of the retractor assembly of FIG. 5 with the outer member in the non-loading or unlocked condition.

FIG. 8 is a side view of the retractor assembly of FIG. 5 with the outer member in the loading or locked condition.

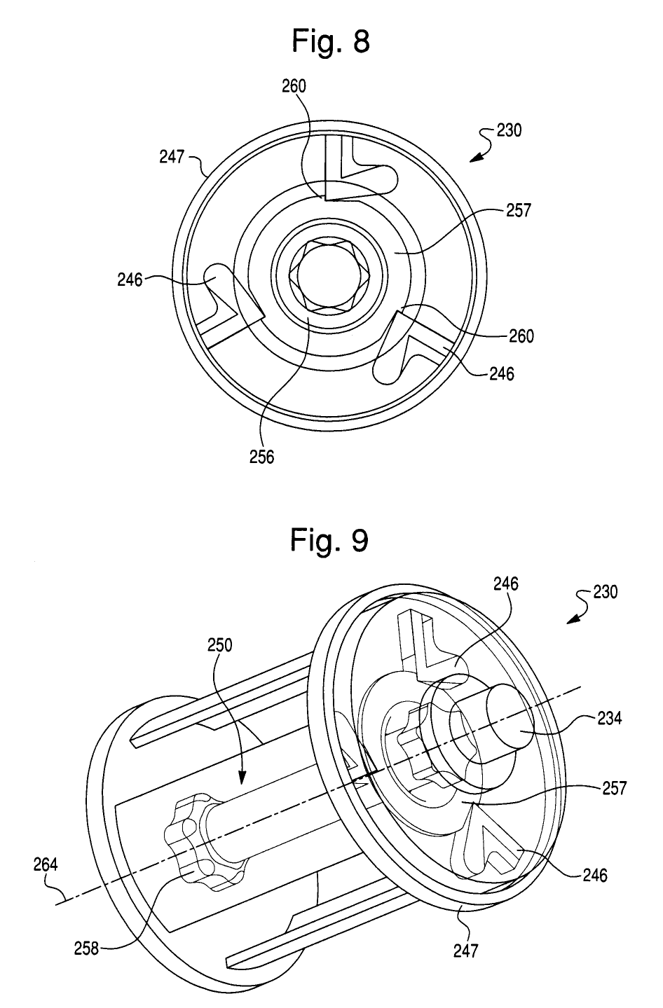

FIG. 9 is a perspective view of the retractor assembly of FIG. 5 with the outer member in the loading or locked condition.

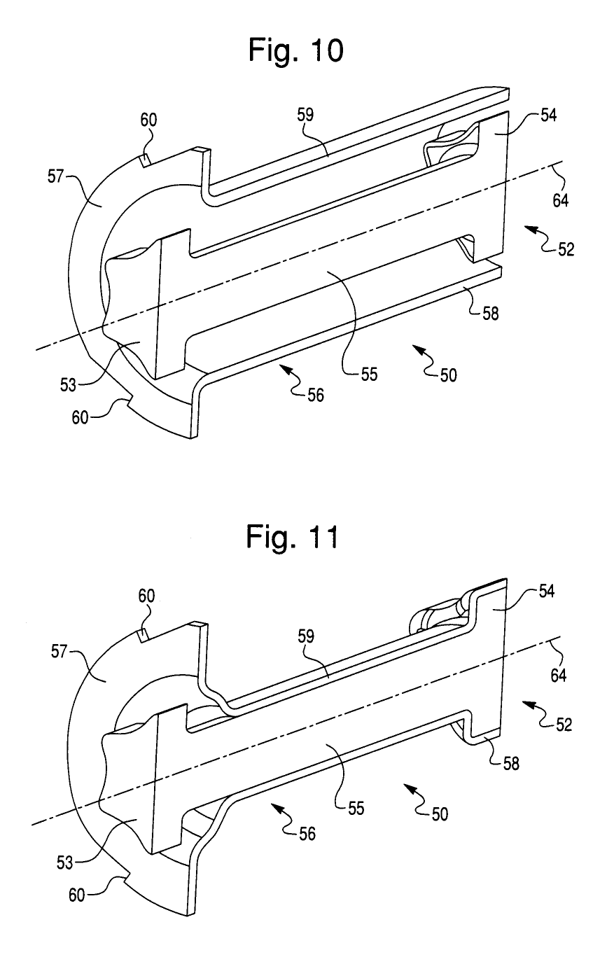

FIG. 10 is an exemplary embodiment of a torsion bar assembly, prior to coupling the outer and inner members, for use within a retractor mechanism, such as the retractor assembly of FIG. 4.

FIG. 11 is an exemplary embodiment of a torsion bar assembly, after coupling the outer and inner members, for use within a retractor mechanism assembly, such as the retractor assembly of FIG. 4.

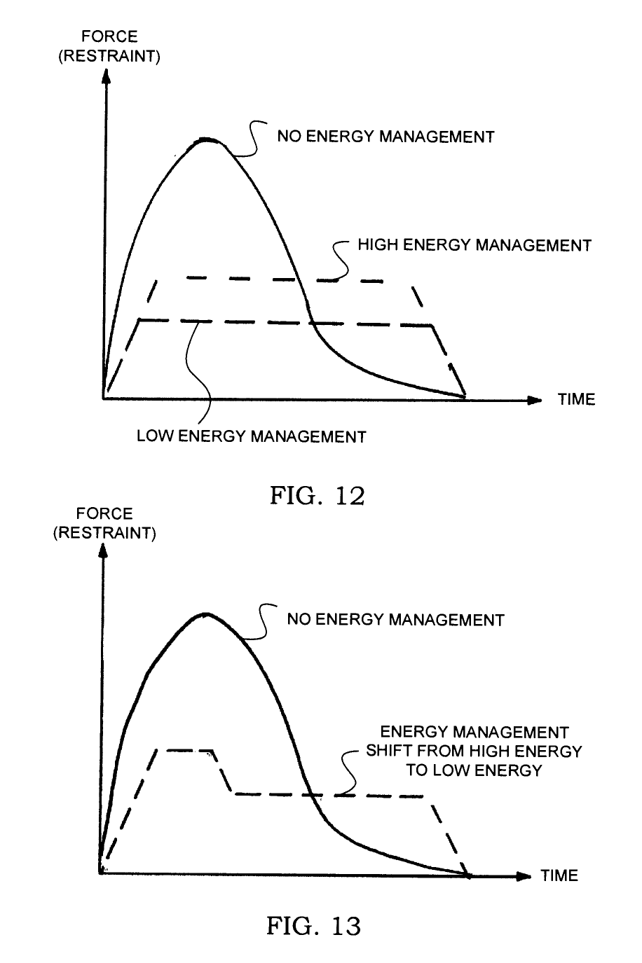

FIG. 12 is a graph illustrating the restraint force over time.

FIG. 13 is a graph illustrating the restraint force over time.

### DETAILED DESCRIPTION

Referring to FIG. 1, an exemplary embodiment of a safety or seat belt system 20 is shown and includes a seat assembly 22, a buckle mechanism 24, an anchor member 25, a tongue member 26, a belt webbing 27, and a retractor assembly 30. The webbing 27 may be coupled at one end to the anchor member 25, and may be coupled at the other end to the retractor assembly 30. The anchor member 25 may be pivotably coupled to the seat assembly 22, and the retractor assembly 30 may be fixedly coupled to the seat assembly 22. Alternatively, the retractor assembly 30 may be mounted to the floor of the vehicle. The tongue member 26 may be slidably coupled to the webbing 27, so that the tongue member 26 may move along the length of webbing 27. The tongue member 26 may be disengagably coupled to the buckle mechanism 24, which may be pivotably coupled to the seat assembly 22 or a portion of the vehicle such as the floor, for example.

As shown in FIG. 1, the seat belt system 20 includes various components (e.g., buckle mechanism 24, anchor member 25, tongue member 26, webbing 27, retractor assembly 30) integrated with seat assembly 22, so that safety system 20 manages all occupant loads exerted onto webbing 27 during a vehicle dynamic impact event. According to other embodiments, the safety components (e.g., buckle mechanism 24, anchor member 25, tongue member 26, webbing 27, retractor assembly 30) may not be integrated directly with seat assembly 22, and may be coupled to the vehicle or other vehicle components.

Referring to FIG. 2, another exemplary embodiment of a safety system 20 is shown and includes at least one load limiting device 21, a buckle mechanism 24, an anchor member 25, a tongue member 26, a webbing 27, a D-ring member 28, and a retractor assembly 30. The webbing 27 may be coupled at one end to the retractor assembly 30, and may be coupled at the other end to a first load limiting device 21, which is also coupled to the anchor member 25. The D-ring member 28 includes a slot, which may be slidably coupled to the webbing 27, and includes a hole, which may be pivotably coupled to the vehicle. The tongue member 26 may be slidably coupled to the webbing 27, so that the tongue member 26 may move along the length of webbing 27. The tongue member 26 may be disengagably coupled to the buckle mechanism 24, which may be coupled to a second load limiting device 21. The retractor assembly 30, the anchor member 25, and the second load limiting device 21 may be coupled to the vehicle or some other component contained within the vehicle, such as a seat.

The system shown in FIG. 2 includes two types of seat belt pretensioners. At the anchor end of the seat belt adjacent the load limiting device 21, a cylinder piston type pretensioner is provided. A piston is fired in a cylinder, typically by a pyrotechnic device, to corresponding pull the seat belt webbing and tension the seat belt. The retractor may also include a pretensioner 40. The pretensioner may be initiated by an explosive charge, that during a vehicle high-speed dynamic impact event rapidly generates gas to create pressure to move a piston that may drive a rack, ball bearings, or any other member that may be coupled to a pinion gear through a teeth mesh. The pinion may be coupled directly or indirectly, through a member or hub, to a torsion shaft or bar coupled to the spool, whereby rotation of the pinion transmits torque through the torsion bar into the spool, creating torque to retract the webbing and tension the seat belt. The pretensioners may be deployed when sensors on the vehicle detect an impact event and are typically designed to deploy at high speed impacts. Although two pretensioners are shown in FIG. 2, a seat belt system may include one, two or no pretensioners.

Referring to FIG. 3, another exemplary embodiment of a safety system 20 is shown and includes an anchor member 25, a tongue member 26, a webbing 27, a D-ring member 28, and a retractor assembly 30. The webbing 27 may be coupled at one end to the retractor assembly 30 and coupled at the other end to the anchor member 25. The D-ring member 28 includes a slot, which may be slidably coupled to the webbing 27, and includes a hole, which may be pivotably coupled to the vehicle. The tongue member 26 may be slidably coupled to the webbing 27, so that the tongue member 26 may move along the length of webbing 27. The retractor assembly 30 and the anchor member 25 may be coupled to the vehicle or some other component contained within the vehicle, such as a seat.

Referring to FIG. 4, an exemplary embodiment of a retractor assembly 30 for use within safety system 20 is shown and includes a pretensioner 40, a spool 32, a dual load level torsion bar assembly 50, a frame 44, a lock mechanism 38, and a lock base 36. The second end 34 of the spool 32 may be detachably coupled to the pretensioner 40, whereby the firing of the pretensioner 40 engages the coupling and rotates the spool 32 (and hence the seat belt webbing 27) in the retraction direction. The second ends 54, 58 of the torsion bar assembly 50 may be coupled to the second end 34 of the spool 32, the first end 53 of the inner member 52 of the torsion bar assembly 50 may be coupled to the lock base 36, and the first end 57 of the outer member 56 of the torsion bar assembly 50 may be detachably coupled to the engaging members 46. The engaging members 46 pivot about lock base 36 into and out of engagement with the first end 57 of the outer member 56 of torsion bar assembly 50. The lock base 36 may be detachably coupled to the lock mechanism 38 and/or frame 44 through a locking method, when the lock mechanism 38 is triggered. This locking method, according to an exemplary embodiment, may be achieved through a pawl, which may be triggered mechanically (e.g., spring force). According to another embodiment the pawl may be triggered by inertia.

The retractor assembly 30 includes a torsion bar or torsion bar assembly 50 configured to provide different levels of torsional strength in order to provide different energy absorption characteristics. During a vehicle dynamic impact event that imparts low level loading (i.e., low restraint forces on the occupant), the locking mechanism 38 may engage the lock base 36 through a locking method (thus engaging the first end 53 of the inner member 52 of the torsion bar assembly 50), but the first end 57 of the outer member 56 of the torsion bar assembly 50 remains disengaged from the lock base 36, since engaging member 46 is not engaged with first end 57. Thus during low level loading incidents, the safety system 20 may use the low level loading configuration of the retractor assembly 30, whereby torsional loading occurs only through the inner member 52 of the torsion bar assembly 50. The lock base 36 coupled to the frame 44 through the locking mechanism 38 holds the first end 53 of the inner member 52 of the torsion bar assembly 50 fixed, while the restraint forces transfer from the occupant to the seat belt webbing 27 to the spool 32, inducing a torque about the rotating or longitudinal axis 64 of the spool 32. The second ends 54, 58 of the torsion bar assembly 50 coupled to the spool 32 are subjected to the torque. As a result, the torsion bar assembly 50 manages the lower level loading by deforming elastically and plastically between its ends through only the torsion section 55 of the inner member 52.

During a vehicle dynamic impact event that imparts high level loading (i.e., high restraint forces on the occupant), the locking mechanism 38 may engage the lock base 36 through a locking method. The locking mechanism engages the first end 53 of the inner member 52 of the torsion bar assembly 50 and may also engage the first end 57 of the outer member 56 of the torsion bar assembly 50 through engaging members 46. Thus, during high level loading incidents, the safety system 20 may use the high level loading configuration of the retractor assembly 30, whereby torsional loading occurs through both the inner and outer members 52, 56 of the torsion bar assembly 50. The lock base 36 is coupled to the frame 44 through the locking mechanism 38 and holds the first end 53 of the inner member 52 and the first end 57 of the outer member 56 fixed, while the restraint forces transfer from the occupant to the seat belt webbing 27 to the spool 32, inducing a torque about the rotational axis 64 of the spool 32. The second ends 54, 58 of the torsion bar assembly 50 are coupled to the spool 32 and are subjected to the torque applied by the seat belt to the spool. The torsion bar assembly 50 manages the higher level loading by deforming elastically and plastically between its ends through both the inner and outer members.

According to another exemplary embodiment, the low level loading may be managed only through the loading of the first end 57 of the outer member 56 of the torsion bar assembly 50. In this configuration, the first end 57 of the outer member 56 of the torsion bar assembly 50 is coupled to the lock base 36, and the first end 53 of the inner member 52 of the torsion bar assembly 50 is detachably coupled to the lock base 36 through engaging members 46.

According to an exemplary embodiment, an engaging member 46 may be a pawl, and according to other embodiments, an engaging member 46 may be a pinion or other useful device or method to provide detachable coupling. During high level loading, the engaging member 46 may engage and couple the first end 57 of the outer member 56 of the torsion bar assembly 50 to the lock base 36 and, as a result, loading occurs through both sections (inner and outer members 52, 56) in order to manage the higher restraint forces and improve occupant protection. According to another embodiment, during high level loading, the engaging member 46 may engage and couple the first end 57 of the outer member 56 of the torsion bar assembly 50 to the first end 33 of spool 32 and loading would occur through both the inner and outer members 52, 56 to manage the higher restraint forces and improve occupant protection.

Referring to FIG. 5, another exemplary embodiment of a retractor assembly 130 for use within safety system 20 is shown and includes a pretensioner 140, a spool 132, a torsion bar or torsion bar assembly 150, a frame 144, a lock mechanism 138, and a lock base 136. The second end 134 of the spool 132 may be detachably coupled to the pretensioner 140, whereby the firing of the pretensioner 140 engages the coupling and rotates the spool 132 and the seat belt webbing 27 in the retraction direction. The second ends 154, 158 of the torsion bar assembly 150 may be coupled to the lock base 136, the first end 153 of the inner member 152 of the torsion bar assembly 150 may be coupled to the second end 134 of spool 132, and the first end 157 of the outer member 156 of the torsion bar assembly 150 may be detachably coupled to the engaging members 146. The engaging members 146 pivot about spool 132 into and out of engagement with the first end 157 of the outer member 156 of torsion bar assembly 150. The lock base 136 may be detachably coupled to the lock mechanism 138 and/or frame 144 through a locking method, when the lock mechanism 138 is triggered. This locking method, according to an exemplary embodiment, may be achieved through a pawl, which may be triggered mechanically (e.g., spring force). According to another embodiment the pawl may be triggered by inertia.

The retractor assembly 130 constructed using a dual load level torsion bar assembly 150 assembly 150 may provide different levels of torsional strength, to provide improved safety depending on the severity of the incident. During a vehicle dynamic impact event that imparts low level loading (i.e., low restraint forces on the occupant), the locking mechanism 138 may engage the lock base 136 through a locking method, thus locking both second ends 154, 158 of the torsion bar assembly 150. The first end 153 of the inner member 152 of the torsion bar assembly 150 is engaged to the second end 134 of spool 132, but the first end 157 of the outer member 156 of the torsion bar assembly 150 remains disengaged from engaging member 146. Thus, during low level loading incidents, the safety system 20 may use the low level loading configuration of the retractor assembly 130, whereby torsional loading occurs only through the inner member 152 of the torsion bar assembly 150. The lock base 136 coupled to the frame 144 through the locking mechanism 138 holds the second end 154 of the inner member 152 of the torsion bar assembly 150 fixed, while the restraint forces transfer from the occupant to the seat belt webbing 27 to the spool 132, inducing a torque about the rotational axis 164 of the spool 132. The first end 153 of the inner member 152 of the torsion bar assembly 150 being coupled to the spool 132 is subjected to this torque, and the torsion bar assembly 150 manages the lower level loading (reducing occupant restraint forces) by deforming elastically and plastically between its ends through only the torsion section 155 of the inner member 152.

During a vehicle dynamic impact event that imparts high level loading (i.e., high restraint forces on the occupant), the locking mechanism 138 may engage the lock base 136 through a locking method, thus locking both second ends 154, 158 of the torsion bar assembly 150. The first end 153 of the inner member 152 of the torsion bar assembly 150 is engaged to the second end 134 of spool 132, and the first end 157 of the outer member 156 of the torsion bar assembly 150 is engaged by engaging member 146. Thus during high level loading incidents, the safety system 20 may use the high level loading configuration of the retractor assembly 130, whereby torsional loading occurs through both the inner and outer members 152, 156 of the torsion bar assembly 150. The lock base 136 coupled to the frame 144 through the locking mechanism 138 holds both second ends 154, 158 fixed, while the restraint forces transfer from the occupant to the seat belt webbing 27 to the spool 132, inducing a torque about the rotational axis 164 of the spool 132. The first ends 153, 157 of the torsion bar assembly 150 being coupled to the spool 132 is subjected to this torque, and the torsion bar assembly 150 manages the higher level loading (reducing occupant restraint forces) by deforming elastically and plastically between its ends through both sections (inner and outer members).

Referring to FIGS. 6 and 7, a portion of the retractor assembly 230 is shown to illustrate the disengagement between the first end 257 of the outer member 256 of torsion bar assembly 250 and engaging members 246, for low level loading. According to an exemplary embodiment, engaging members 246 may be kept in the unlocked or disengaged position with respect to locking feature 260 of first end 257 of torsion bar assembly 250 by a force (e.g., spring, electromagnet, or other device), whereby during low level loading, the engaging members 246 may rotate without transferring torque into the first end 257 of the outer member 256 of torsion bar assembly 250. According to an exemplary embodiment, retractor assembly 230 includes three engaging members 246, which are substantially equidistant apart in the radial direction. According to other embodiments, retractor assembly 230 may include any number of engaging members 246, being positioned anywhere about the rotational axis 264.

Referring to FIGS. 8 and 9, a portion of the retractor assembly 230 is shown to illustrate the engagement between the first end 257 of the outer member 256 of torsion bar assembly 250 and engaging members 246, for high level loading. According to an exemplary embodiment, during a vehicle dynamic impact event that imparts high level loading (i.e., high restraint forces on the occupant), ring member 247 displaces in the direction towards the engaging members 246 along the rotational axis 264. This displacement may be achieve through an explosive device (e.g., pyrotechnic), an electromagnetic device, or other useful device. According to an exemplary embodiment, engaging member 246 may have a cam or ramp surface that is engaged by the leading edge of ring member 247, and as the ring member 247 continues to displace in the direction towards the engaging member 246, this displacement causes engaging members 246 to rotate towards the inside of the retractor assembly 230 and into engagement with the locking feature 260 of the first end 257 of the outer member 256 of torsion bar assembly 250. Ring member 247 may stop displacing and remain fixed in a position that prohibits engaging members 246 from disengaging first end 257. Once engaging members 246 are locked with the first end 257 of torsion bar assembly 250, torque may be transferred through spool 232 into the outer member 256 of torsion bar assembly 250. According to other embodiments, engaging member 246 may be rotated using other methods.

Referring to FIG. 10, an exemplary embodiment of a torsion bar assembly 50 (load limiting device) is shown prior to coupling the inner member 52 and outer member 56. According to an exemplary embodiment, the inner member 52 may be made from steel, alloy or other material having the required mechanical (e.g., strength) properties to absorb the predetermined torque, and may be made through conventional methods such as forging, broaching, machining, or any combination thereof. The inner member 52 includes a first end 53 and a second end 54, whereby each end may be configured to transfer torque. According to an exemplary embodiment, the first and second ends 53, 54 may have a male key-way feature (e.g., spline, polygon, star-shaped) that may engage a corresponding female feature of a coupled member, thereby transferring torque between the two members. The first end 53 of the inner member 52 may be coupled to the lock base 36, and the second end 54 of the inner member 52 may be coupled to the second end 34 of spool 32 (that may be coupled to the pretensioner 40). According to an exemplary embodiment, the outer member 56, prior to coupling to the inner member 52, may be a relatively thin walled tube having a first end 57 configured with a flared wall, which runs substantially perpendicular to the rotational axis 64 and base wall 59 of the outer member 56. The flared wall of the first end 57 of the outer member 56 may have at least one locking feature 60 (e.g., locking teeth, ratchet step) along the outer surface, and during high level loading, the locking feature 60 is engaged by engaging member 46, to transfer torque. The outer member 56 may further include a second end 58, which may be an extension of the base wall 59, prior to coupling to the inner member 52. The outer member 56 may be made from steel, alloy or other material having the required mechanical (e.g., strength) properties to absorb the predetermined torque, and may be made through conventional methods such as forging, stamping, extruding, roll forming or any combination thereof.

According to other embodiments, the inner member 52 of the torsion bar assembly 50 may comprise multiple pieces coupled together. For example, the ends 53, 54 of inner member 52, may be separate members, made of steel (or other useful material) through a casting process (or other useful process), having two key-way features to transfer torque, an inner and outer feature. The torsion section 55 of inner member 52 may be made of steel (or other useful material) through an extrusion process (or other useful process), having an outer key-way feature to transfer torque on each end. The ends 53, 54 may be coupled using a coupling method onto the torsion section 55, whereby the inner key-way of the ends 53, 54 couple to the outer key-way features of the ends of the torsion section 55. According to an exemplary embodiment, this coupling method may be press-fit, and according to other embodiments, it may be welding, or broaching. According to other embodiments, the ends 53, 54 of the inner member 52 may have other features to transfer the predetermined torque (e.g., female key-ways that couple to male key-ways, gears, magnets). According to other embodiments, the fist and second ends of the inner member may couple to other components, such as directly to a pretensioner 40, a cam, a hub, a housing, a locking mechanism 38, or other component of an energy managing retractor assembly 30.

Referring to FIG. 11, an exemplary embodiment of a torsion bar assembly 50 (load limiting device) is shown after the outer member 56 has been coupled to the inner member 52. According to an exemplary embodiment, the outer member 56 may be coupled to the inner member 52 through magnetic pulse forming or magnetic pulse crimping, whereby a high energy current is discharged through a coil that surrounds the outer member 56 inducing a strong magnetic field. Electromagnetic forces between the coil and outer member are generated by the strong magnetic field that cause the base wall 59 of the outer member 56 to collapse onto and conform to the outer shape of the inner member 52, including any torque transmission feature, such as the torque transmission feature of the second end 54 of the inner member 52. Following coupling of the outer member 56 to the inner member 52, the flared wall of the first end 57 of the outer member 56 remains substantially perpendicular to the rotational axis 64 of the torsion bar assembly 50. According to other embodiments, the outer member of the torsion bar assembly 50 may be coupled to the inner member through other methods, such as hydro-forming, or explosive forming.

The coupling of the inner member 52 to the outer member 56 creates a torsionally weaker section (when compared to the rest of the torsion bar) that includes the base wall 59 of the outer member 56 on top of the torsion section 55 of the inner member 52, and it is this section which is constructed to deform elastically and yield plastically, when subjected to torsional loading. According to an exemplary embodiment, the torsion bar assembly 50 shown in FIG. 11 may provide a duel level of energy management, a high level and a low level. During a sudden vehicle impact imparting a high level loading, such as from one involving high vehicle speed and/or a larger mass occupant, the vehicle sensors will prompt the safety system to provide high level energy management. During high level energy management, the torsion bar assembly 50 may be constructed to deform and yield through both the torsion section 55 of the inner member 52 and the base wall 59 of the outer member 56, whereby both torque transmitting features of the torsion bar assembly 50 (i.e., through both the first end 53 of the inner member 52 of the torsion bar assembly 50 and the flared wall of the first end 57 of the outer member 56 of the torsion bar assembly 50) are engaged to transfer torque. During low level energy management, the torsion bar assembly 50 may be constructed to deform and yield only through either the torsion section 55 or the base wall 59, but not both, whereby torque may be transmitted into either one of the two torque transmitting features (i.e., either through the first end 53 of the inner member 52 of the torsion bar assembly 50 or through the flared wall of the first end 57 of the outer member 56 of the torsion bar assembly 50).

Referring to FIG. 12, a graph illustrating different curves of restraint force versus time is shown. A conventional retractor assembly without an energy management system produces high restraint forces over a short period of time as illustrated. A retractor assembly 30 having an energy management system reduces the magnitude of the restraint forces exerted onto the occupant and extends the restraint forces over a longer time, which improves the occupant safety and mitigates possibility of occupant injury. Two levels of energy management are illustrated, one being high energy management, while the other being low energy management. According to an exemplary embodiment of an energy management retractor having a duel level torsion bar assembly 50 (as disclosed in this application), two levels of energy management could be provided based on communication from the safety system. During a vehicle impact event, the safety system of the vehicle could analyze parameters (e.g., mass of the occupant, speed of the vehicle) and evaluate the level of energy management required to optimize occupant protection, then communicate to the energy management retractor the level of energy management required, whereby the retractor assembly 30 would load through either one or both members of the torsion bar assembly 50.

Referring to FIG. 13, a graph illustrating different curves of restraint force versus time is shown. Again, a conventional retractor assembly without an energy management system produces high restraint forces over a short period of time as illustrated. A retractor assembly 30 having an energy management system reduces the magnitude of the restraint forces exerted onto the occupant and extends the restraint forces over a longer time, which improves the occupant safety and mitigates possibility of occupant injury. According to an exemplary embodiment of an energy management retractor assembly 30 having a duel level torsion bar assembly 50 (as disclosed in this application), the restraint force may be shifted, for example, from a high level energy management system to a low level energy management system at any time. Accordingly a shift from low energy to high energy management may also be done.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the torsion bar assembly 50 as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A retractor for a vehicle seat belt comprising:
a spool configured to rotate so that the seat belt may be wound and unwound from around the spool;
a torsion bar located inside the spool, wherein the torsion bar includes an inner member and an outer member;
a lock mechanism for preventing rotation of the spool;
a biasing mechanism for biasing the rotation of the spool in the belt winding direction;
wherein a first end of the spool and a first end of the inner member and the outer members are configured to be connected to the lock mechanism;
wherein a second end of the spool and a second end of the torsion bar are connected together and wherein the second ends of the spool and the torsion bar are connected to the biasing mechanism;
wherein the retractor is configured so that the inner or outer members are selectively connected to the lock mechanism and so that during a first loading condition either the first end of the inner member or the first end of the outer member is fixed to the lock mechanism and during a second loading condition both of the first ends of the inner and outer members are connected to the lock mechanism.

2. The retractor of claim 1, further comprising a pretensioner configured to force the spool to rotate in the belt winding direction in the event of an accident involving the vehicle.

3. The retractor of claim 1, wherein the first end of the outer member includes a flared wall.

4. The retractor of claim 3, wherein the flared wall includes a notched section configured to engage the locking mechanism.

5. The retractor of claim 3, wherein the inner member and the outer member are substantially in contact along the entire length of the torsion bar except for the first end.

6. The retractor of claim 5, wherein the flared wall extends in a direction substantially perpendicular to the longitudinal axis of the torsion bar.

7. The retractor of claim 1, wherein the inner member and the outer member are substantially in contact along the entire length of the torsion bar except for the first end.

8. A seat belt system for a vehicle, wherein the system includes a retractor and a seat belt webbing, wherein the retractor comprises:
a spool configured to rotate so that the webbing may be wound and unwound from around the spool;
a lock mechanism for preventing rotation of the spool and withdrawal of the webbing;
a torsion bar located inside the spool, wherein a first end of the torsion bar is connected to the lock mechanism and a second end of the torsion bar is connected to the spool;
wherein the torsion bar includes inner and outer members and wherein the retractor is configured so that the inner or outer members are selectively connected to the lock mechanism so that during a first loading condition either the first end of the inner member or the first end of the outer member is fixed to the lock mechanism and during a second loading condition both of the first ends of the inner and outer members are fixed to the lock mechanism.

9. The system of claim 8, wherein the retractor further comprises a biasing mechanism for urging the spool in the webbing winding direction.

10. The system of claim 8, further comprising a pretensioner for rapidly rotating the spool in the webbing winding direction in the event of an accident involving the vehicle.

11. The system of claim 8, wherein the inner member and the outer member are substantially in contact along the entire length of the torsion bar except for the first end.

12. A retractor for a vehicle seat belt comprising:
a spool configured to rotate so that the seat belt may be wound and unwound from around the spool;
a torsion bar located inside the spool, wherein the torsion bar includes an inner member and an outer member;
a lock mechanism for preventing rotation of the spool;
a biasing mechanism for biasing the rotation of the spool in the belt winding direction;
wherein a first end of the spool and a first end of the inner member and the outer members are configured to be connected to the lock mechanism;
wherein a second end of the spool and a second end of the torsion bar are connected together and wherein the second ends of the spool and the torsion bar are connected to the biasing mechanism;
wherein the inner and outer members of the torsion bar are substantially in contact along the entire length of the torsion bar except for the first end.
wherein the retractor is configured so that the inner or outer members are selectively connected to the lock mechanism and so that during a first loading condition either the first end of the inner member or the first end of the outer member is fixed to the lock mechanism and during a second loading condition both of the first ends of the inner and outer members are connected to the lock mechanism.

13. The retractor of claim 12, further comprising a pretensioner configured to force the spool to rotate in the belt winding direction in the event of an accident involving the vehicle.

14. The retractor of claim 12, wherein the first end of the outer member includes a flared wall.

15. The retractor of claim 14, wherein the flared wall includes a notched section configured to engage the locking mechanism.

16. The retractor of claim 14, wherein the flared wall extends in a direction substantially perpendicular to the longitudinal axis of the torsion bar.
